(19) United States
(12) Patent Application Publication
(10) Pub. No.: US 2024/0426672 A1
(43) Pub. Date: Dec. 26, 2024

(54) METHOD FOR DETECTING COLOR TEMPERATURE, APPARATUS FOR DETECTING COLOR TEMPERATURE, AND ELECTRONIC DEVICE

(71) Applicant: SHENZHEN GOODIX TECHNOLOGY CO., LTD., Shenzhen (CN)

(72) Inventors: Guannan FAN, Shenzhen (CN); Jianwei JIANG, Shenzhen (CN)

(73) Assignee: SHENZHEN GOODIX TECHNOLOGY CO., LTD., Shenzhen (CN)

(21) Appl. No.: 18/829,606

(22) Filed: Sep. 10, 2024

Related U.S. Application Data
(63) Continuation of application No. PCT/CN2023/118004, filed on Sep. 11, 2023.

(30) Foreign Application Priority Data
Sep. 30, 2022 (CN) 202211213962.6

(51) Int. Cl. G01J 5/60; G01J 5/02; G01J 5/53

(52) U.S. Cl. CPC G01J 5/60; G01J 5/0275; G01J 5/53; G01J 2005/608

(57) ABSTRACT

Provided is a method and apparatus for detecting a color temperature, and an electronic device, which can accurately detect a color temperature of a light source. The method includes: determining, based on multi-channel data of a to-be-tested light source and multi-channel data of a first standard light source group, proportional coefficients corresponding to the first standard light source group, where the proportional coefficients corresponding to the first standard light source group is used to represent a ratio between multi-channel data of each standard light source in the first standard light source group and the multi-channel data of the to-be-tested light source; determining a tristimulus value of the to-be-tested light source based on the multi-channel data of the first standard light source group and the proportional coefficients corresponding to the first standard light source group; and determining a color temperature of the to-be-tested light source based on the tristimulus value.

### CROSS-REFERENCE TO RELATED APPLICATIONS AND INCORPORATION BY REFERENCE

The present disclosure is a continuation of international application No. PCT/CN2023/118004, filed on Sep. 11, 2023, which claims the priority to the patent application for invention with the Chinese application number 202211213962.6 titled “METHOD FOR DETECTING COLOR TEMPERATURE, APPARATUS FOR DETECTING COLOR TEMPERATURE, AND ELECTRONIC DEVICE” filed with the China National Intellectual Property Administration on Sep. 30, 2022, both of which are incorporated herein by reference in their entireties.

### TECHNICAL FIELD

Embodiments of the present disclosure relate to the field of optical sensors, and more specifically relate to a method for detecting color temperature, an apparatus for detecting color temperature, and an electronic device.

### BACKGROUND

With the development of electronic devices such as mobile phones, more electronic devices need to have a function of automatically regulating a color temperature of a screen based on external ambient light. Therefore, how to accurately compute the color temperature based on ambient light data has become a to-be-solved problem.

### SUMMARY

Embodiments of the present disclosure provide a method for detecting a color temperature, an apparatus for detecting a color temperature, and an electronic device, which can accurately detect a color temperature of a light source.

In a first aspect, a method for detecting a color temperature is provided, including: determining, based on multi-channel data of a to-be-tested light source and multi-channel data of a first standard light source group, proportional coefficients corresponding to the first standard light source group, where the proportional coefficients corresponding to the first standard light source group is used to represent a ratio between multi-channel data of each standard light source in the first standard light source group and the multi-channel data of the to-be-tested light source; determining a tristimulus value of the to-be-tested light source based on the multi-channel data of the first standard light source group and the proportional coefficients corresponding to the first standard light source group; and determining a color temperature of the to-be-tested light source based on the tristimulus value.

In an embodiment of the present disclosure, a standard light source group is used to characterize the to-be-tested light source, the proportional coefficient between multi-channel data of each standard light source in the standard light source group and the multi-channel data of the to-be-tested light source is determined based on the multi-channel data of the to-be-tested light source and the multi-channel data of each standard light source in the standard light source group, the tristimulus value of the to-be-tested light source is determined based on the multi-channel data of the standard light source group and the corresponding proportional coefficients thereof, and then the color temperature of the to-be-tested light source is determined based on the tristimulus value. When applied to ambient light detection below a screen of an electronic device, this method can effectively improve color temperature computation errors caused by non-uniform transmittance of the screen to light in different wavebands.

In an implementation, before the determining the tristimulus value of the to-be-tested light source, the method further includes: determining, based on the multi-channel data of the to-be-tested light source and multi-channel data of M standard light source groups, the first standard light source group from the M standard light source groups, where the number of standard light sources in each standard light source group is N, the M standard light source groups include a combination of any N standard light sources in a standard light source set, M is a positive integer greater than 1, and N is a positive integer greater than 1.

In this embodiment, the first standard light source group that best matches the to-be-tested light source is selected from the M standard light source groups, the tristimulus value of the to-be-tested light source is determined based on the multi-channel data of the first standard light source group and the corresponding proportional coefficients thereof, and then the color temperature of the to-be-tested light source is determined based on the tristimulus value, thereby further improving the accuracy of color temperature detection.

In an implementation, the determining, based on the multi-channel data of the to-be-tested light source and the multi-channel data of the M standard light source groups, the first standard light source group from the M standard light source groups includes: determining, based on the multi-channel data of the to-be-tested light source and multi-channel data of an i-th standard light source group among the M standard light source groups, proportional coefficients corresponding to the i-th standard light source group, where i ranges from 1 to M; determining multi-channel data of a fitted light source of the to-be-tested light source obtained by fitting the i-th standard light source group based on the multi-channel data of the i-th standard light source group and the proportional coefficients corresponding to the i-th standard light source group; and determining, based on a Euclidean distance between the multi-channel data of the fitted light source and the multi-channel data of the to-be-tested light source, a standard light source group with a shortest Euclidean distance among the M standard light source groups as the first standard light source group, where the Euclidean distance is used to represent a deviation between the multi-channel data of the to-be-tested light source and the multi-channel data of the fitted light source.

In this embodiment, because there is the shortest Euclidean distance between the multi-channel data of the fitted light source obtained by fitting based on the multi-channel data of the first standard light source group and the corresponding proportional coefficients thereof and the multi-channel data of the to-be-tested light source, the tristimulus value of the to-be-tested light source computed based on the multi-channel data of the first standard light source group and the corresponding proportional coefficients thereof is best.

The Euclidean distance may be, for example, an arithmetic square root of a quadratic sum of data differences of same channels in the multi-channel data of the to-be-tested light source and the multi-channel data of the fitted light source.

In an implementation, the proportional coefficients corresponding to the i-th standard light source group are a best solution obtained by solving an equation set T=S×Coef based on non-negative linear least squares, where T represents the multi-channel data of the to-be-tested light source, S represents the multi-channel data of the i-th standard light source group, and Coef represents the proportional coefficients corresponding to the i-th standard light source group. Since the equation set T=S×Coef may be an overdetermined equation set without a real number solution, the best solution of the proportional coefficients Coef can be obtained by the non-negative linear least squares.

In an implementation, the determining the tristimulus value of the to-be-tested light source based on the multi-channel data of the first standard light source group and the proportional coefficients corresponding to the first standard light source group includes: determining the tristimulus value of the to-be-tested light source based on the multi-channel data of the first standard light source group, the proportional coefficients corresponding to the first standard light source group, and a conversion coefficient corresponding to each standard light source in the first standard light source group, where the conversion coefficient corresponding to each standard light source is used to represent a relationship between multi-channel data of each standard light source and a tristimulus value thereof.

In this embodiment, a relationship between RGB data of each standard light source and the tristimulus value thereof may be represented by a conversion coefficient, based on which, the RGB data of the standard light source can be converted into the tristimulus value thereof. The tristimulus value of the to-be-tested light source can be effectively determined based on the tristimulus value of each standard light source in the first standard light source group and the corresponding proportional coefficient and conversion coefficient thereof.

For example, the tristimulus value of the to-be-tested light source is a sum of tristimulus values of N standard light sources in the first standard light source group, where the tristimulus value of each standard light source is a product of RGB channel data of each standard light source, a proportional coefficient corresponding to each standard light source, and the conversion coefficient corresponding to each standard light source.

In an implementation, the determining the color temperature of the to-be-tested light source based on the tristimulus value includes: determining chromaticity coordinates of the to-be-tested light source based on the tristimulus value; and determining the color temperature based on the chromaticity coordinates.

For example, the determining the color temperature based on the chromaticity includes: determining coordinates the color temperature based on CCT=449n³+3525n²+6823.3n+5520.33, where n=(x−0.3320)/(0.1858−y), CCT is a correlated color temperature of the to-be-tested light source, and x and y are the chromaticity coordinates.

In an implementation, the multi-channel data includes data of a red light channel, data of a green light channel, data of a blue light channel, data of a visible light channel, and data of an unfiltered light channel, i.e., the multi-channel data includes data of RGBCW channels.

In an implementation, the standard light source set includes at least two of: 2600K near blackbody light source, 3000K near blackbody light source, 4000K near blackbody light source, 5000K near blackbody light source, 6000K near blackbody light source, 7000K near blackbody light source, 8000K near blackbody light source, 2600K LED light source, 3000K LED light source, 4000K LED light source, 5000K LED light source, 6000K LED light source, 7000K LED light source, 8000K LED light source, D65 light source, TL84 light source, TL83 light source, CWF light source, F/A light source, incandescent light source, D75 light source, or D50 light source.

In a second aspect, an apparatus for detecting a color temperature is provided, including: an RGB sensor configured to collect multi-channel data of a to-be-tested light source; and a processor configured to: determine, based on the multi-channel data of the to-be-tested light source and multi-channel data of a first standard light source group, proportional coefficients corresponding to the first standard light source group, where the proportional coefficients corresponding to the first standard light source group are used to represent a ratio between multi-channel data of each standard light source in the first standard light source group and the multi-channel data of the to-be-tested light source; determine a tristimulus value of the to-be-tested light source based on the multi-channel data of the first standard light source group and the proportional coefficients corresponding to the first standard light source group; and determine a color temperature of the to-be-tested light source based on the tristimulus value.

In an implementation, the processor is further configured to: determine, based on the multi-channel data of the to-be-tested light source and multi-channel data of M standard light source groups, the first standard light source group from the M standard light source groups, where the number of standard light sources in each standard light source group is N, the M standard light source groups include a combination of any N standard light sources in a standard light source set, M is a positive integer greater than 1, and N is a positive integer greater than 1.

In an implementation, the processor is specifically configured to: determine, based on the multi-channel data of the to-be-tested light source and multi-channel data of an i-th standard light source group among the M standard light source groups, proportional coefficients corresponding to the i-th standard light source group, where i ranges from 1 to M; determine multi-channel data of a fitted light source of the to-be-tested light source obtained by fitting the i-th standard light source group based on the multi-channel data of the i-th standard light source group and the proportional coefficients corresponding to the i-th standard light source group; and determine, based on a Euclidean distance between the multi-channel data of the fitted light source and the multi-channel data of the to-be-tested light source, a standard light source group with a shortest Euclidean distance among the M standard light source groups as the first standard light source group, where the Euclidean distance is used to represent a deviation between the multi-channel data of the to-be-tested light source and the multi-channel data of the fitted light source.

In an implementation, the Euclidean distance may be an arithmetic square root of a quadratic sum of data differences of same channels in the multi-channel data of the to-be-tested light source and the multi-channel data of the fitted light source.

In an implementation, the proportional coefficients corresponding to the i-th standard light source group are a best solution obtained by solving an equation set T=S×Coef based on non-negative linear least squares, where T represents the multi-channel data of the to-be-tested light source, S represents the multi-channel data of the i-th standard light source group, and Coef represents the proportional coefficients corresponding to the i-th standard light source group.

In an implementation, the processor is specifically configured to: determine the tristimulus value of the to-be-tested light source based on the multi-channel data of the first standard light source group, the proportional coefficients corresponding to the first standard light source group, and a conversion coefficient corresponding to each standard light source in the first standard light source group, where the conversion coefficient corresponding to each standard light source is used to represent a relationship between multi-channel data of each standard light source and a tristimulus value thereof.

In an implementation, the tristimulus value of the to-be-tested light source is a sum of tristimulus values of N standard light sources in the first standard light source group, where the tristimulus value of each standard light source is a product of RGB channel data of each standard light source, a proportional coefficient corresponding to each standard light source, and the conversion coefficient corresponding to each standard light source.

In an implementation, the processor is specifically configured to: determine chromaticity coordinates of the to-be-tested light source based on the tristimulus value; and determine the color temperature based on the chromaticity coordinates.

In an implementation, the determining the color temperature based on the chromaticity coordinates includes: determining the color temperature based on CCT=449n³+3525n²+6823.3n+5520.33, where n=(x−0.3320)/(0.1858−y), CCT is a correlated color temperature of the to-be-tested light source, and x and y are the chromaticity coordinates.

In an implementation, the multi-channel data includes data of a red light channel, data of a green light channel, data of a blue light channel, data of a visible light channel, and data of an unfiltered light channel.

In an implementation, the standard light source set includes at least two of: 2600K near blackbody light source, 3000K near blackbody light source, 4000K near blackbody light source, 5000K near blackbody light source, 6000K near blackbody light source, 7000K near blackbody light source, 8000K near blackbody light source, 2600K LED light source, 3000K LED light source, 4000K LED light source, 5000K LED light source, 6000K LED light source, 7000K LED light source, 8000K LED light source, D65 light source, TL84 light source, TL83 light source, CWF light source, F/A light source, incandescent light source, D75 light source, or D50 light source.

In a third aspect, an electronic device is provided, including: a screen; and the apparatus for detecting a color temperature according to the second aspect or any one possible implementation in the second aspect arranged below the screen for detecting a color temperature of ambient light in which the electronic device is located.

### BRIEF DESCRIPTION OF DRAWINGS

FIG. 1 is a standard observer color matching function;

FIG. 2 is a color space chromaticity diagram;

FIG. 3 is a schematic diagram of transmittance of a screen to light in different wavebands;

FIG. 4 is a schematic diagram of a relationship curve between B/R and an ideal blackbody color temperature;

FIG. 5 is a schematic diagram of an RGB sensitometric curve;

FIG. 6 is a schematic diagram of comparison between a fitted tristimulus value and a standard tristimulus value;

FIG. 7 is a schematic flowchart of a method for detecting a color temperature in an embodiment of the present disclosure;

FIG. 8 is a schematic diagram of RGBCW data of several standard light sources; and

FIG. 9 is a schematic block diagram of an apparatus for detecting a color temperature in an embodiment of the present disclosure.

### DESCRIPTION OF EMBODIMENTS

Technical solutions of the present disclosure will be described below with reference to the drawings.

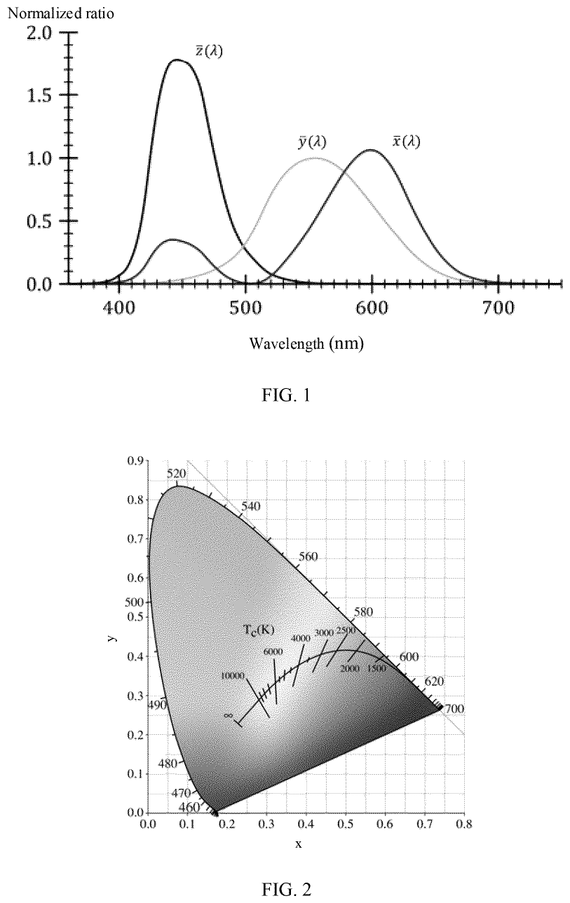

The International Commission on Illumination (CIE) implemented a three primary color matching experiment in 1931, and defined a standard observer color matching function and XYZ tristimulus values to quantify color attributes observed by human eyes. For the standard observer color matching function as shown in FIG. 1, tristimulus values XYZ (hereinafter also referred to as tristimulus values) corresponding to any color with spectral power distribution I(λ) are respectively:

X=∫₀^{∞}1(λ)x̅(λ)dλ;

Y=∫₀^{∞}1(λ)y̅(λ)d)λ; and

Z=∫₀^{∞}1(λ)z̅(λ)dλ;
where x̅(λ), y̅(λ), and z̅(λ) are color matching functions corresponding to red (R), green (G), and blue (B) respectively.

Tristimulus values XYZ of a spectrum can be understood as contents of three specified stimuli required to match the spectrum, that is, contents of ideal red (R), ideal green (G), and ideal blue (B) in the spectrum.

In addition, the CIE further set out a color space chromaticity diagram as shown in FIG. 2 for quantifying chromaticity coordinates of colors. The tristimulus valuesXYZ are converted into chromaticity coordinates xy based on:

$$\\ x = \frac{X}{X + Y + Z} ; and y = \frac{Y}{X + Y + Z} .$$

The chromaticity coordinates satisfy z=1−x−y. After x and y are constant, z is also constant. Therefore, the chromaticity coordinates shown in FIG. 2 are only formed by x and y, where x is the abscissa, and y is the ordinate, equivalent to compressing z-direction data into x and y coordinate planes.

A color temperature of a light source is defined as a Kelvin temperature (unit: K) of a blackbody radiator that emits light similar to the light source. FIG. 2 shows coordinates of colors at different color temperatures in the chromaticity diagram. The arc shown in FIG. 2 is a blackbody trajectory, and a plurality of short lines intersecting with the blackbody trajectory are isochromatic lines.

When light emitted from the light source is close to, but not coincident with, a point on the blackbody trajectory, description is provided with a Correlated Color Temperature (CCT). A common computing method for the CCT at a position (x, y) on the chromaticity diagram is an approximation formula McCamy:

CCT=449n³+3525n²+6823.3n+5520.33, where n=(x−0.3320)/(0.1858−y).

At present, common optical sensors on the market include an XYZ sensor, an RGB sensor, and a multispectral sensor. A spectral response curve of the XYZ sensor is very close to the CIE standard, from which accurate chromaticity coordinates xy can be obtained, and then an accurate CCT can be computed based on the chromaticity coordinates xy. However, its manufacturing process is complex with high costs. The RGB sensor mainly responds to three colors of light: red (R), green (G), and blue (B). It is necessary to convert RGB data collected by the RGB sensor into tristimulus values XYZ in some ways, and then compute the CCT based on the tristimulus values XYZ. The manufacturing process of the RGB sensor is simple with low costs, but it is very difficult to highly accurately convert the collected RGB data into the tristimulus values XYZ, and the accuracy of the finally obtained tristimulus valuesXYZ is poor. The multispectral sensor describes light source spectrum using a large number of channels, and is more often used in scenarios with very high requirements for accuracy, and its costs are very high.

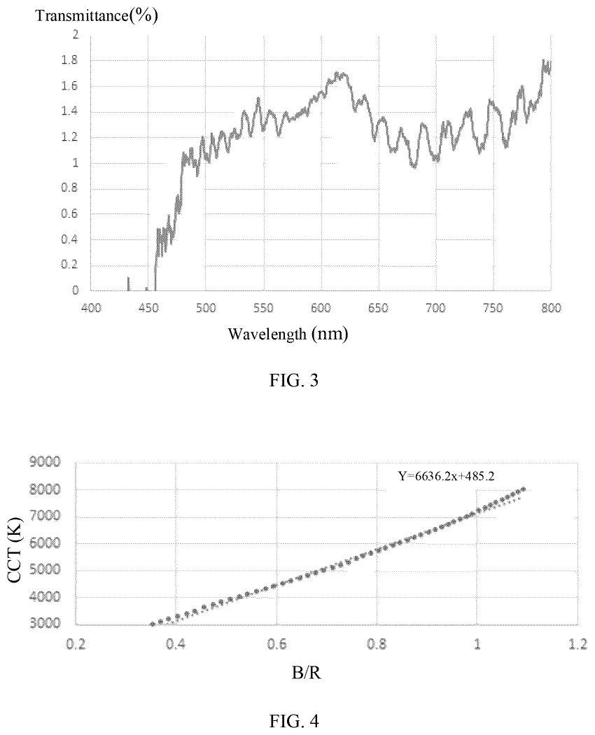

With the development of electronic devices such as mobile phones, more electronic devices need to have a function of automatically regulating a color temperature of a screen based on external ambient light. The RGB sensor is more easily used in color temperature detection due to its advantages of simple process and low costs. The RGB sensor may be arranged below a screen of an electronic device, and may detect ambient light transmitted from the screen. However, for example, as shown in FIG. 3, transmittance of a glass cover plate of the screen to light in different wavebands is non-uniform, which exacerbates errors introduced by conversion of the RGB data into the tristimulus values XYZ, so that it is difficult to obtain an accurate color temperature.

Therefore, the accuracy of color temperature detection can be improved in the following ways.

In one way, a large amount of spectral data of a standard light source is collected, and data of the corresponding RGB channel and tristimulus values XYZ of a standard instrument such as an illuminometer are recorded, thereby computing a best conversion relationship between the RGB data and the tristimulus values XYZ. The standard light source may be a standard light source defined by an organization such as the CIE, a near-ideal blackbody light source, a common light source, or the like. In this way, in a practical application, this conversion relationship can be used to convert the RGB data collected by the RGB sensor into the tristimulus values XYZ, and then compute the CCT based on the tristimulus values XYZ.

For example, a D50 standard light source is used to illuminate each color block in standard 24 color cards, and sensed values [Rᵢ Gᵢ Bᵢ] and [Xᵢ Yᵢ Zᵢ] of a reflected light spectrum of each color block by the RGB sensor and the standard instrument are recorded.

$$\\ [ {R}_{i} {G}_{i} {B}_{i} ] = [ \begin{matrix}{R}_{1} {G}_{1} {B}_{1} \\ {R}_{2} {G}_{2} {B}_{2} \\ ⋯ \\ {R}_{24} {G}_{24} {B}_{24}\end{matrix} ] ; and [ {X}_{i} {Y}_{i} {Z}_{i} ] = [ \begin{matrix}{X}_{1} {Y}_{1} {Z}_{1} \\ {X}_{2} {Y}_{2} {Z}_{2} \\ ⋯ \\ {X}_{24} {Y}_{24} {Z}_{24}\end{matrix} ] .$$

An equation set

$$\\ [ \begin{matrix}{R}_{1} {G}_{1} {B}_{1} \\ {R}_{2} {G}_{2} {B}_{2} \\ ⋯ \\ {R}_{24} {G}_{24} {B}_{24}\end{matrix} ] * M = [ \begin{matrix}{X}_{1} {Y}_{1} {Z}_{1} \\ {X}_{2} {Y}_{2} {Z}_{2} \\ ⋯ \\ {X}_{24} {Y}_{24} {Z}_{24}\end{matrix} ]$$

is established, where M is conversion coefficients, or referred to as a conversion matrix, between the RGB data and the tristimulus values XYZ. This equation set is solved using an algebraic method, to obtain a conversion coefficient M, which may also be referred to as a conversion matrix M.

In a practical application, after the RGB sensor collects the RGB data of the to-be-tested light source, the tristimulus values XYZ of the to-be-tested light source can be obtained based on [X Y Z]=[R G B]*M, and then the CCT can be computed based on the tristimulus values XYZ.

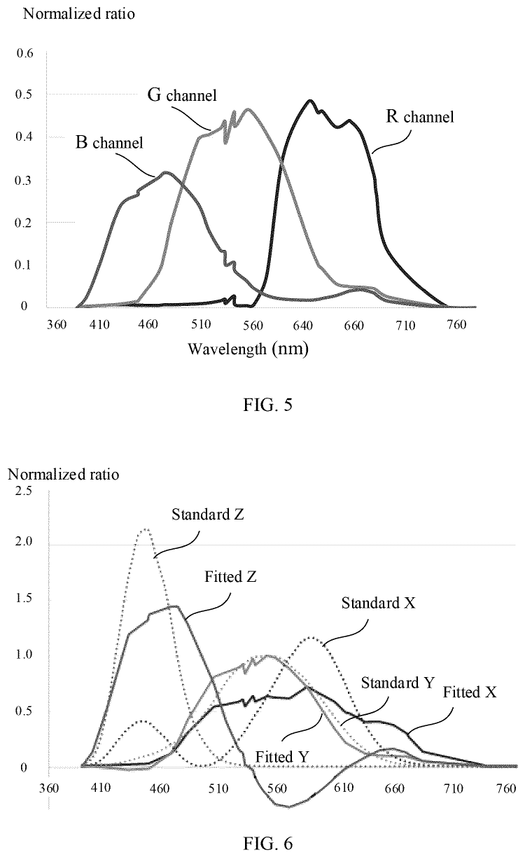

However, for this method, the RGB data collected by the RGB sensor cannot be accurately converted into standard tristimulus values XYZ based on the conversion coefficient M. For example, as shown in FIGS. 5 and 6, FIG. 5 is an RGB sensitometric curve collected by the RGB sensor. Based on FIG. 5, the RGB data of the to-be-tested light source can be obtained. FIG. 6 is tristimulus values XYZ (fitted X, fitted Y, and fitted Z shown as solid lines) and standard tristimulus values XYZ of the CIE (standard X, standard Y, and standard Z shown as dotted lines) converted from the RGB data based on the conversion coefficient M. It can be seen that there is great difference between tristimulus values X and Z and standard values, thereby resulting in intolerable computation errors for some light sources. In fact, it was found through extensive validation that computing the tristimulus values XYZ using the single conversion coefficient M will cause very large computation errors of tristimulus values XYZ of some types of light sources or mixed light sources.

In another way, the CCT may be estimated using the characteristic that the ideal blackbody color temperature is approximately linear on the chromaticity diagram. As can be seen from the blackbody trajectory shown in FIG. 2, a trajectory at a color temperature of 3000K-8000K shows an approximately linear relationship. Therefore, a ratio B/R of data of a B channel to data of an R channel collected by the RGB sensor and color temperature values thereof can be fitted to obtain a linear function, such as the relationship curve between the B/R and the ideal blackbody color temperature shown in FIG. 4, so as to roughly estimate the CCT using this linear function. Here, since the red waveband is spaced far from the blue waveband with a small overlapped region, a relatively accurate linear function can be obtained by fitting the B/R value and the color temperature values. This method does not need to compute chromaticity coordinates x and y, and is not adapted to a scenario where it is necessary to obtain the chromaticity coordinates; and a correlated color temperature that is not on the blackbody trajectory will be relatively greatly different using this method.

Generally, the spectrum f(λ) may be composed of N spectra denoted as f₁(λ), f₂(λ) . . . fₙ(λ), and then f(λ)=f₁(λ)+f₂(λ)+ . . . +fₙ(λ).

Therefore, standard tristimulus values of the CIE are X=∫₀^{+∞}f(λ)*x̅(λ)dλ=∫₀^{+∞}(f₁(λ)+f₂(λ)+ . . . +fₙ(λ)*x̅(λ)dλ=∫₀^{+∞}f₁(λ)*x̅(λ)dλ+∫₀^{+∞}f₂(λ)*x̅(λ)dλ+ . . . +∫₀^{+∞}fₙ(λ)*x̅(λ) dλ=X₁+X₂+ . . . +Xₙ.

Similarly, Y=Y₁+Y₂+ . . . +Yₙ; and Z=Z₁+Z₂+ . . . +Zₙ can be obtained.

Hence, stimulus values XYZ of each spectrum may be composed of a plurality of tristimulus value components. The RGB sensor cannot accurately convert RGB data of all light sources into tristimulus values XYZ thereof using the single conversion coefficient M. Therefore, in the embodiment of the present disclosure, the to-be-tested light source may be regarded as a combination of a plurality of component light sources, tristimulus values XYZ of the plurality of component light sources are computed respectively, and then the tristimulus values XYZ of the plurality of component light sources are summed to obtain tristimulus values XYZ of the to-be-tested light source.

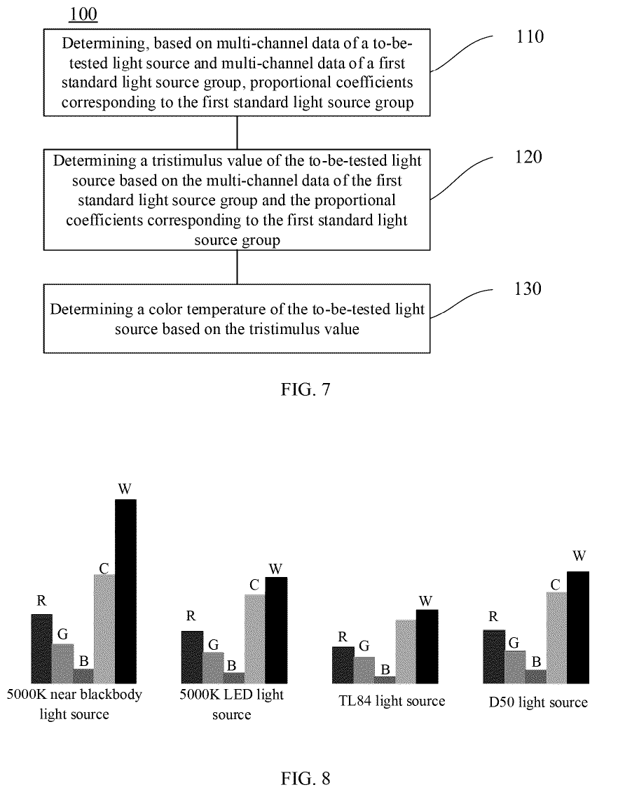

The method for detecting a color temperature in the embodiment of the present disclosure is described in detail below with reference to FIGS. 7 and 8.

FIG. 7 shows the method for detecting a color temperature in an embodiment of the present disclosure. As shown in FIG. 7, the method 100 for detecting a color temperature includes some or all of the following steps.

Step 110: determining, based on multi-channel data of a to-be-tested light source and multi-channel data of a first standard light source group, proportional coefficients corresponding to the first standard light source group.

The proportional coefficients corresponding to the first standard light source group is used to represent a ratio between multi-channel data of each standard light source in the first standard light source group and the multi-channel data of the to-be-tested light source, and reflects a proportion of contribution of each standard light source in the first standard light source group to the to-be-tested light source to a certain extent.

Step 120: determining a tristimulus value of the to-be-tested light source based on the multi-channel data of the first standard light source group and the proportional coefficients corresponding to the first standard light source group.

Step 130: determining a color temperature of the to-be-tested light source based on the tristimulus value of the to-be-tested light source.

The color temperature may be the above-mentioned CCT.

Here, the multi-channel data is data collected on different color channels of an RGB sensor. The more the mutually independent channels are, the more accurately the characteristics of the to-be-tested light source are described, and the better the matching algorithm effects are. Therefore, the number of channels can be increased to improve the accuracy of the detection results, but the corresponding costs and computational complexity will also be increased. For example, the multi-channel data may include R channel data, G channel data, and B channel data; or, the multi-channel data may include R channel data, G channel data, B channel data, and C channel data, and W channel data. The R channel is a color filter (CF) channel that only transmits red light, the G channel is a CF channel that only transmits green light, the B channel is a CF channel that only transmits blue light, and the W channel is a channel without light filtering. The method 100 is described in detail below taking the multi-channel including RGBCW channels as an example.

In an embodiment of the present disclosure, a standard light source group is used to characterize the to-be-tested light source, the proportional coefficient between multi-channel data of each standard light source in the standard light source group and the multi-channel data of the to-be-tested light source is determined based on the multi-channel data of the to-be-tested light source and the multi-channel data of each standard light source in the standard light source group, tristimulus values XYZ of the to-be-tested light source are determined based on the multi-channel data of the standard light source group and the corresponding proportional coefficients thereof, and then the color temperature of the to-be-tested light source is determined based on the tristimulus values XYZ. When the method 100 is applied to ambient light detection below a screen of an electronic device, the method 100 can effectively improve color temperature computation errors caused by non-uniform transmittance of the screen to light in different wavebands.

The first standard light source group may include specified N standard light sources, where N is a positive integer greater than 1. The smaller the number N of standard light sources is, the faster the computation speed is, but the poorer the accuracy is; and the larger the number N is, the higher the accuracy is, but the slower the computation speed is. An appropriate N value can be determined based on actual situation. Preferably, N is less than or equal to 3.

The first standard light source group may also be a standard light source group selected from M standard light source groups, where M is a positive integer greater than 1, and the number of standard light sources in each standard light source group is less than or equal to N. That is, a standard light source group is selected from the M standard light source groups for color temperature detection of a current to-be-tested light source. The first standard light source group that best matches the to-be-tested light source is selected from the M standard light source groups, the tristimulus values XYZ of the to-be-tested light source are determined based on the multi-channel data of the first standard light source group and the corresponding proportional coefficients thereof, and then the color temperature of the to-be-tested light source is determined based on the tristimulus values XYZ, thereby further improving the accuracy of color temperature detection.

The M standard light source groups may include any combination of standard light sources with a number less than N in the standard light source set. For example, the M standard light source group may be M standard light source groups obtained by traversing all possible N standard light sources in the standard light source set.

The standard light source set may include, for example, at least two of the following standard light sources: 2600K near blackbody light source, 3000K near blackbody light source, 4000K near blackbody light source, 5000K near blackbody light source, 6000K near blackbody light source, 7000K near blackbody light source, 8000K near blackbody light source, 2600K LED light source, 3000K LED light source, 4000K LED light source, 5000K LED light source, 6000K LED light source, 7000K LED light source, 8000K LED light source, D65 light source, TL84 light source, TL83 light source, CWF light source, F/A light source, incandescent light source, D75 light source, or D50 light source.

The larger the number of standard light sources in the standard light source set is, the higher the computational accuracy may be, but the lower the computation speed may be. The number of standard light sources in the standard light source set can be reduced to effectively improve the computation speed. The number of standard light sources in the standard light source set is adjusted to balance between the detection accuracy and computation speed.

Each standard light source in the standard light source set has its own multi-channel data and a conversion coefficient M for converting its RGB data into its tristimulus values XYZ, etc.

In an implementation, in the method 100, before the determining the tristimulus values XYZ of the to-be-tested light source, the first standard light source group may be determined from the M standard light source groups based on the multi-channel data of the to-be-tested light source and multi-channel data of each standard light source in the M standard light source groups.

For example, first, based on the multi-channel data of the to-be-tested light source and multi-channel data of an i-th standard light source group among the M standard light source groups, proportional coefficients corresponding to the i-th standard light source group are determined, where i ranges from 1 to M; second, multi-channel data of a fitted light source of the to-be-tested light source obtained by fitting the i-th standard light source group is determined based on the multi-channel data of the i-th standard light source group and the proportional coefficients corresponding to the i-th standard light source group; and finally, based on a Euclidean distance between the multi-channel data of the fitted light source and the multi-channel data of the to-be-tested light source, a standard light source group with a shortest Euclidean distance among the M standard light source groups is determined as the first standard light source group.

The Euclidean distance represents a deviation between the multi-channel data of the to-be-tested light source and the multi-channel data of the fitted light source. For example, the Euclidean distance may be expressed as an arithmetic square root of a quadratic sum of data differences of same channels in the multi-channel data of the to-be-tested light source and the multi-channel data of the fitted light source.

The multi-channel data of the to-be-tested light source is expressed as T, the multi-channel data of the i-th standard light source group is expressed as S, the proportional coefficients corresponding to the i-th standard light source group is expressed as Coef, and an equation set T=S×Coef may be established, where Coef represents a proportional coefficient between multi-channel data of each standard light source in the i-th standard light source group and the multi-channel data of the to-be-tested light source. Since the equation set T=S×Coef may be an overdetermined equation set without a real number solution, a best solution of Coef can be obtained by solving the equation set T=S×Coef using an appropriate computing mode, e.g., non-negative linear least squares. For example, a relevant method published by Lawson and Hanson in 1974 may be referred to for the non-negative linear least squares, which will not be repeated here for the sake of brevity.

For example, the RGB sensor has five channels RGBCW. First, it is necessary to acquire RGBCW data T of the to-be-tested light source collected by the RGB sensor, and select RGBCW data S of the i-th standard light source group in the M standard light source groups from a data set. Assume that each standard light source group includes three standard light sources S1, S2, and S3.

$$\\ T = [ \begin{matrix}{R}_{T} \\ {G}_{T} \\ {B}_{T} \\ {C}_{T} \\ {W}_{T}\end{matrix} ] ; S = [ \begin{matrix}{R}_{s 1} & {R}_{s 2} & {R}_{s 3} \\ {G}_{s 1} & {G}_{s 2} & {G}_{s 3} \\ {B}_{s 1} & {B}_{s 2} & {B}_{s 3} \\ {C}_{s 1} & {C}_{s 2} & {C}_{s 3} \\ {W}_{s 1} & {W}_{s 2} & {W}_{s 3}\end{matrix} ] ; and Coef = [ \begin{matrix}{Coef}_{s 1} \\ {Coef}_{s 2} \\ {Coef}_{s 3}\end{matrix} ] .$$

$$\\ An equation set [ \begin{matrix}{R}_{T} \\ {G}_{T} \\ {B}_{T} \\ {C}_{T} \\ {W}_{T}\end{matrix} ] = [ \begin{matrix}{R}_{s 1} & {R}_{s 2} & {R}_{s 3} \\ {G}_{s 1} & {G}_{s 2} & {G}_{s 3} \\ {B}_{s 1} & {B}_{s 2} & {B}_{s 3} \\ {C}_{s 1} & {C}_{s 2} & {C}_{s 3} \\ {W}_{s 1} & {W}_{s 2} & {W}_{s 3}\end{matrix} ] \times [ \begin{matrix}{Coef}_{s 1} \\ {Coef}_{s 2} \\ {Coef}_{s 3}\end{matrix} ]$$

is established, and Coef is computed. This equation set is an overdetermined equation set, and may not have a real number solution. Therefore, the best solution of Coef can be obtained using, for example, the non-negative linear least squares. The best solution is denoted as Coef_{best}.

Second, RGBCW data of the fitted light source obtained by fitting the standard light sources S1, S2, and S3 is determined, and is expressed as F. An equation set

$$\\ F = [ \begin{matrix}{R}_{s 1} & {R}_{s 2} & {R}_{s 3} \\ {G}_{s 1} & {G}_{s 2} & {G}_{s 3} \\ {B}_{s 1} & {B}_{s 2} & {B}_{s 3} \\ {C}_{s 1} & {C}_{s 2} & {C}_{s 3} \\ {W}_{s 1} & {W}_{s 2} & {W}_{s 3}\end{matrix} ] \times {Coef}_{best}$$

is established, and a Euclidean distance D_{FT} between the RGBCW data T of the to-be-tested light source and RGBCW data F of the fitted light source thereof is computed. The D_{FT} may be, for example, an arithmetic square root of a quadratic sum of data differences of same channels in the F and T.

The above-mentioned computation is performed successively on RGBCW data of the M standard light source groups, to obtain a Euclidean distance between RGBCW data T of the fitted light source obtained by fitting each standard light source group and RGBCW data F of the to-be-tested light source, and select a standard light source group corresponding to the shortest Euclidean distance as the first standard light source group.

In this way, the first standard light source group is determined from the M standard light source groups. Because there is the shortest Euclidean distance between the multi-channel data of the fitted light source obtained by fitting based on the multi-channel data of the first standard light source group and the corresponding proportional coefficients thereof and the multi-channel data of the to-be-tested light source, the tristimulus values XYZ of the to-be-tested light source computed based on the multi-channel data of the first standard light source group and the corresponding proportional coefficients thereof are best.

After the first standard light source group is determined, the tristimulus values XYZ of the to-be-tested light source need to be computed based on relevant data of the first standard light source group. In an implementation, the step 120 includes: determining the tristimulus value of the to-be-tested light source based on the multi-channel data of the first standard light source group, the proportional coefficients corresponding to the first standard light source group, and a conversion coefficient corresponding to each standard light source in the first standard light source group, where the conversion coefficient corresponding to each standard light source is used to represent a relationship between multi-channel data of each standard light source and a tristimulus value thereof.

For example, the tristimulus values XYZ of the to-be-tested light source are a sum of tristimulus values of N standard light sources in the first standard light source group, where the tristimulus value of each standard light source is a product of RGB channel data of each standard light source, a proportional coefficient corresponding to each standard light source, and the conversion coefficient corresponding to each standard light source.

A relationship between RGB data of each standard light source in the first standard light source group and the tristimulus value thereof is represented by the corresponding conversion coefficient. Assume that standard light sources in the first standard light source group include P1, P2, and P3, and conversion coefficients corresponding to the standard light sources P1, P2, and P3 are Mₚ₁, Mₚ₂, and Mₚ₃ respectively. RGB data of the standard light sources P1, P2, and P3 are [Rₚ₁ Gₚ₁ Bₚ₁], [Rₚ₂ Gₚ₂ Bₚ₂], [Rₚ₃ Gₚ₃ Bₚ₃] respectively. Best solutions of proportional coefficients corresponding to the standard light sources P1, P2, and P3 obtained based on the above-mentioned steps are Coefₚ₁, Coefₚ₂, Coefₚ₃ respectively, that is

$$\\ {Coef}_{best} = [ \begin{matrix}{Coef}_{p 1} \\ {Coef}_{p 2} \\ {Coef}_{p 3}\end{matrix} ] .$$

Therefore, the tristimulus values XYZ of the to-be-tested light source are:

$$\\ [ XYZ ] = {Coef}_{p 1} * [ {R}_{p 1} {G}_{p 1} {B}_{p 1} ] * {M}_{p 1} + {Coef}_{p 2} * [ {R}_{p 2} {G}_{p 2} {B}_{p 2} ] * {M}_{p 2} + {Coef}_{p 3} * [ {R}_{p 3} {G}_{p 3} {B}_{p 3} ] * {M}_{p 3} .$$

It can be seen that in the embodiment of the present disclosure, the to-be-tested light source is regarded as a combination of a standard light source group, and a best light source combination, that is, the first standard light source group, is found from the standard light source set to fit the to-be-tested light source, and obtain a proportion of RGBCW data of each standard light source in the first standard light source group to RGBCW data of the to-be-tested light source, such that RGBCW=RGBCW1×Coef₁+RGBCW2×Coef₂+ . . . +RGBCWn×Coefₙ. FIG. 8 shows RGBCW data of several standard light sources.

After proportional coefficients Coef₁ and Coefₙ corresponding to each standard light source in the first standard light source group are obtained, the tristimulus value of each standard light source in the first standard light source group can be obtained based on RGB data, corresponding proportional coefficient and conversion coefficient thereof, that is, XYZ1=RGB1×Coef₁×M1, XYZ2=RGB2×Coef₂×M2, . . . , XYZn=RGBn×Coefₙ×Mn. The tristimulus value of each standard light source in the standard light source group is summed, to obtain the tristimulus value of the to-be-tested light source XYZ=XYZ1+XYZ2+ . . . +XYZn.

In an implementation, in the step 130, the determining the color temperature of the to-be-tested light source based on the tristimulus values XYZ includes: determining chromaticity coordinates xy of the to-be-tested light source based on the tristimulus values XYZ; and determining the color temperature of the to-be-tested light source based on the chromaticity coordinates xy.

For example, the chromaticity coordinates x and y of the to-be-tested light source are x=X/(X+Y+Z) and y=X/(X+Y+Z) respectively.

For example, the correlated color temperature of the to-be-tested light source is CCT=449n³+3525n²+6823.3n+5520.33, where n=(x−0.3320)/(0.1858−y).

As can be seen from extensive testing, the method 100 for detecting a color temperature in the embodiment of the present disclosure can greatly improve the computational accuracy of CCT. For a single light source, the computation errors of CCT can be controlled within 5%. For a relatively complex light source or combined light source, the computation errors of CCT can be controlled within 10%. Compared with a computational accuracy of 15% that can be achieved by computing CCT using a conventional method, the method 100 for detecting a color temperature in the present disclosure can more accurately detect a color temperature of a light source, and effectively solve the problem of poor adaptability of a single conversion coefficient caused by non-uniform transmittance of the screen to light in different wavebands, so that the RGB sensor can be widely used below the screen to achieve under-display optical detection.

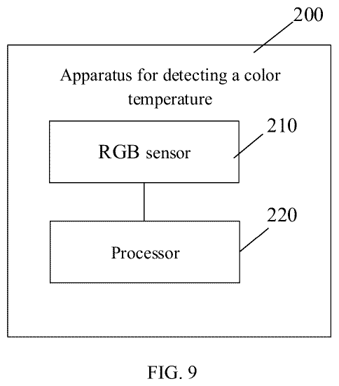

An embodiment of the present disclosure further provides an apparatus 200 for detecting a color temperature. As shown in FIG. 9, the apparatus 200 for detecting a color temperature includes an RGB sensor 210 and a processor 220. The apparatus 200 is configured to execute the method 100 in any one of the above embodiments. The processor 220 may be integrated into a same chip as the RGB sensor 210; or may be provided independently of the RGB sensor 210. For example, the processor 220 may be a processor of an electronic device, such as a CPU.

The RGB sensor 210 is configured to: collect multi-channel data of a to-be-tested light source.

The processor 220 is configured to: determine, based on multi-channel data of a to-be-tested light source and multi-channel data of a first standard light source group, proportional coefficients corresponding to the first standard light source group, where the proportional coefficients corresponding to the first standard light source group is used to represent a ratio between multi-channel data of each standard light source in the first standard light source group and the multi-channel data of the to-be-tested light source; determine a tristimulus value of the to-be-tested light source based on the multi-channel data of the first standard light source group and the proportional coefficients corresponding to the first standard light source group; and determine a color temperature of the to-be-tested light source based on the tristimulus value.

In an implementation, the processor 220 is further configured to: determine, based on the multi-channel data of the to-be-tested light source and multi-channel data of M standard light source groups, the first standard light source group from the M standard light source groups, where the number of standard light sources in each standard light source group is N, the M standard light source groups include a combination of any N standard light sources in a standard light source set, M is a positive integer greater than 1, and N is a positive integer greater than 1.

In an implementation, the processor 220 is specifically configured to: determine, based on the multi-channel data of the to-be-tested light source and multi-channel data of an i-th standard light source group among the M standard light source groups, a proportional coefficients corresponding to the i-th standard light source group, where i ranges from 1 to M; determine multi-channel data of a fitted light source of the to-be-tested light source obtained by fitting the i-th standard light source group based on the multi-channel data of the i-th standard light source group and the proportional coefficients corresponding to the i-th standard light source group; and determine, based on a Euclidean distance between the multi-channel data of the fitted light source and the multi-channel data of the to-be-tested light source, a standard light source group with a shortest Euclidean distance among the M standard light source groups as the first standard light source group, where the Euclidean distance is used to represent a deviation between the multi-channel data of the to-be-tested light source and the multi-channel data of the fitted light source.

In an implementation, the Euclidean distance may be an arithmetic square root of a quadratic sum of data differences of same channels in the multi-channel data of the to-be-tested light source and the multi-channel data of the fitted light source.

In an implementation, the proportional coefficients corresponding to the i-th standard light source group is a best solution obtained by solving an equation set T=S×Coef based on non-negative linear least squares, where T represents the multi-channel data of the to-be-tested light source, S represents the multi-channel data of the i-th standard light source group, and Coef represents the proportional coefficients corresponding to the i-th standard light source group.

In an implementation, the processor 220 is specifically configured to: determine the tristimulus value of the to-be-tested light source based on the multi-channel data of the first standard light source group, the proportional coefficients corresponding to the first standard light source group, and a conversion coefficient corresponding to each standard light source in the first standard light source group, where the conversion coefficient corresponding to each standard light source is used to represent a relationship between multi-channel data of each standard light source and a tristimulus value thereof.

In an implementation, the tristimulus value of the to-be-tested light source is a sum of tristimulus values of N standard light sources in the first standard light source group, where the tristimulus value of each standard light source is a product of RGB channel data of each standard light source, a proportional coefficient corresponding to each standard light source, and the conversion coefficient corresponding to each standard light source.

In an implementation, the processor 220 is specifically configured to: determine chromaticity coordinates of the to-be-tested light source based on the tristimulus value; and determine the color temperature based on the chromaticity coordinates.

In an implementation, the determining the color temperature based on the chromaticity coordinates includes: determining the color temperature based on CCT-449n³+3525n²+6823.3n+5520.33, where n=(x−0.3320)/(0.1858−y), CCT is a correlated color temperature of the to-be-tested light source, and x and y are the chromaticity coordinates.

It should be understood that relevant descriptions in the above method embodiments may be referred to for specific features of the apparatus 200, which are not repeated here for the sake of brevity.

An embodiment of the present disclosure further provides an electronic device, including: a screen; and the apparatus for detecting a color temperature according to any one of the above-mentioned embodiments, which is arranged below the screen for detecting a color temperature of ambient light in which the electronic device is located. The screen may be, for example, an OLED.

As an example and non-restrictively, the electronic device in an embodiment of the present disclosure may be a portable or mobile computing device, such as a terminal device, a mobile phone, a tablet computer, a notebook computer, a desktop computer, a game device, a vehicle electronic device, or a wearable smart device, or may be other electronic devices, such as an electronic database, an automobile, or an automated teller machine (ATM) of a bank. The wearable smart device includes a device that has full functions and a large size, and can realize complete or partial functions without relying on a smart phone, such as a smart watch or smart glasses, and includes a device that only focuses on a certain type of application functions and needs to be used in cooperation with other devices such as a smart phone, for example, various smart bracelets and smart jewelries for monitoring physical signs.

It should be noted that the embodiments in the present disclosure and/or the technical features in the embodiments may be randomly combined with each other on a non-conflict basis, and the combined technical solutions should also fall into the scope of protection of the present disclosure.

The system, apparatus, and method disclosed in the embodiments of the present disclosure may be implemented by other approaches. For example, some features of the method embodiments described above may be neglected, or may not be performed. The above described apparatus embodiments are merely illustrative, the division of the units is only a logical function division, other division manners may be available during actual implementations, and a plurality of units or components may be combined or may be integrated into another system. In addition, the coupling between the units or the coupling between the components may be direct coupling or indirect coupling, and the above coupling includes electrical, mechanical, or other forms of connection.

Those skilled in the art can clearly understand that, for convenience and simplicity of description, corresponding processes and technical effects in the above method embodiments may be referred to for specific working process of the above described apparatus and device and technical effects thereof, which will not be repeated here.

It should be understood that the specific examples in the embodiments of the present disclosure are provided only to help those skilled in the art to better understand the embodiments of the present disclosure, rather than limiting the scope of the embodiments of the present disclosure. Those skilled in the art may make various improvements and modifications on the basis of the above embodiments, and these improvements or modifications all fall within the scope of protection of the present disclosure.

While the above description merely provides specific embodiments of the present disclosure, the scope of protection of the present disclosure is not limited to the specific embodiments. Any person skilled in the present technical field can easily conceive of alterations or replacements within the technical scope disclosed in the present disclosure. All these alterations or replacements should be encompassed within the scope of protection of the present disclosure. Therefore, the scope of protection of the present disclosure should be determined by the scope of protection of the appended claims.

What is claimed is:

1. A method for detecting a color temperature, comprising:
determining, based on multi-channel data of a to-be-tested light source and multi-channel data of a first standard light source group, proportional coefficients corresponding to the first standard light source group, wherein the proportional coefficients corresponding to the first standard light source group are used to represent a ratio between multi-channel data of each standard light source in the first standard light source group and the multi-channel data of the to-be-tested light source;
determining a tristimulus value of the to-be-tested light source based on the multi-channel data of the first standard light source group and the proportional coefficients corresponding to the first standard light source group; and
determining a color temperature of the to-be-tested light source based on the tristimulus value.

2. The method according to claim 1, wherein before the determining the tristimulus value of the to-be-tested light source, the method further comprises:
determining, based on the multi-channel data of the to-be-tested light source and multi-channel data of M standard light source groups, the first standard light source group from the M standard light source groups, wherein a number of standard light sources in each standard light source group is N, the M standard light source groups comprise a combination of any N standard light sources in a standard light source set, M is a positive integer greater than 1, and N is a positive integer greater than 1.

3. The method according to claim 2, wherein the determining, based on the multi-channel data of the to-be-tested light source and the multi-channel data of the M standard light source groups, the first standard light source group from the M standard light source groups comprises:
determining, based on the multi-channel data of the to-be-tested light source and multi-channel data of an i-th standard light source group among the M standard light source groups, proportional coefficients corresponding to the i-th standard light source group, wherein i ranges from 1 to M;
determining multi-channel data of a fitted light source of the to-be-tested light source obtained by fitting the i-th standard light source group based on the multi-channel data of the i-th standard light source group and the proportional coefficients corresponding to the i-th standard light source group; and
determining, based on a Euclidean distance between the multi-channel data of the fitted light source and the multi-channel data of the to-be-tested light source, a standard light source group with a shortest Euclidean distance among the M standard light source groups as the first standard light source group, wherein the Euclidean distance is used to represent a deviation between the multi-channel data of the to-be-tested light source and the multi-channel data of the fitted light source.

4. The method according to claim 3, wherein the Euclidean distance is an arithmetic square root of a quadratic sum of data differences of same channels in the multi-channel data of the to-be-tested light source and the multi-channel data of the fitted light source.

5. The method according to claim 3, wherein the proportional coefficients corresponding to the i-th standard light source group are a best solution obtained by solving an equation set T=S×Coef based on non-negative linear least squares, wherein T represents the multi-channel data of the to-be-tested light source, S represents the multi-channel data of the i-th standard light source group, and Coef represents the proportional coefficients corresponding to the i-th standard light source group.

6. The method according to claim 1, wherein the determining the tristimulus value of the to-be-tested light source based on the multi-channel data of the first standard light source group and the proportional coefficients corresponding to the first standard light source group comprises:
determining the tristimulus value of the to-be-tested light source based on the multi-channel data of the first standard light source group, the proportional coefficients corresponding to the first standard light source group, and a conversion coefficient corresponding to each standard light source in the first standard light source group, wherein the conversion coefficient corresponding to each standard light source is used to represent a relationship between multi-channel data of the each standard light source and a tristimulus value thereof.

7. The method according to claim 6, wherein the tristimulus value of the to-be-tested light source is a sum of tristimulus values of N standard light sources in the first standard light source group, wherein the tristimulus value of each standard light source is a product of RGB channel data of the each standard light source, a proportional coefficient corresponding to the each standard light source, and the conversion coefficient corresponding to the each standard light source.

8. The method according to claim 1, wherein the determining the color temperature of the to-be-tested light source based on the tristimulus value comprises:
determining chromaticity coordinates of the to-be-tested light source based on the tristimulus value; and
determining the color temperature based on the chromaticity coordinates.

9. The method according to claim 8, wherein the determining the color temperature based on the chromaticity coordinates comprises:
determining the color temperature based on CCT=449n³+3525n²+6823.3n+5520.33, wherein n=(x−0.3320)/(0.1858−y), CCT is a correlated color temperature of the to-be-tested light source, and x and y are the chromaticity coordinates.

10. The method according to claim 1, wherein the multi-channel data comprises data of a red light channel, data of a green light channel, data of a blue light channel, data of a visible light channel, and data of an unfiltered light channel.

11. The method according to claim 2, wherein the standard light source set comprises at least two of:
2600K near blackbody light source, 3000K near blackbody light source, 4000K near blackbody light source, 5000K near blackbody light source, 6000K near blackbody light source, 7000K near blackbody light source, 8000K near blackbody light source, 2600K LED light source, 3000K LED light source, 4000K LED light source, 5000K LED light source, 6000K LED light source, 7000K LED light source, 8000K LED light source, D65 light source, TL84 light source, TL83 light source, CWF light source, F/A light source, incandescent light source, D75 light source, or D50 light source.

12. An apparatus for detecting a color temperature, comprising:
an RGB sensor configured to collect multi-channel data of a to-be-tested light source; and
a processor configured to:
determine, based on the multi-channel data of the to-be-tested light source and multi-channel data of a first standard light source group, proportional coefficients corresponding to the first standard light source group, wherein the proportional coefficients corresponding to the first standard light source group are used to represent a ratio between multi-channel data of each standard light source in the first standard light source group and the multi-channel data of the to-be-tested light source;
determine a tristimulus value of the to-be-tested light source based on the multi-channel data of the first standard light source group and the proportional coefficients corresponding to the first standard light source group; and
determine a color temperature of the to-be-tested light source based on the tristimulus value.

13. The apparatus according to claim 12, wherein the processor is further configured to:
determine, based on the multi-channel data of the to-be-tested light source and multi-channel data of M standard light source groups, the first standard light source group from the M standard light source groups, wherein a number of standard light sources in each standard light source group is N, the M standard light source groups comprise a combination of any N standard light sources in a standard light source set, M is a positive integer greater than 1, and N is a positive integer greater than 1.

14. The apparatus according to claim 13, wherein the processor is specifically configured to:
determine, based on the multi-channel data of the to-be-tested light source and multi-channel data of an i-th standard light source group among the M standard light source groups, proportional coefficients corresponding to the i-th standard light source group, wherein i ranges from 1 to M;
determine multi-channel data of a fitted light source of the to-be-tested light source obtained by fitting the i-th standard light source group based on the multi-channel data of the i-th standard light source group and the proportional coefficients corresponding to the i-th standard light source group; and
determine, based on a Euclidean distance between the multi-channel data of the fitted light source and the multi-channel data of the to-be-tested light source, a standard light source group with a shortest Euclidean distance among the M standard light source groups as the first standard light source group, wherein the Euclidean distance is used to represent a deviation between the multi-channel data of the to-be-tested light source and the multi-channel data of the fitted light source.

15. The apparatus according to claim 14, wherein the proportional coefficients corresponding to the i-th standard light source group are a best solution obtained by solving an equation set T=S×Coef based on non-negative linear least squares, wherein T represents the multi-channel data of the to-be-tested light source, S represents the multi-channel data of the i-th standard light source group, and Coef represents the proportional coefficients corresponding to the i-th standard light source group.

16. The apparatus according to claim 12, wherein the processor is specifically configured to:
determine the tristimulus value of the to-be-tested light source based on the multi-channel data of the first standard light source group, the proportional coefficients corresponding to the first standard light source group, and a conversion coefficient corresponding to each standard light source in the first standard light source group, wherein the conversion coefficient corresponding to each standard light source is used to represent a relationship between multi-channel data of the each standard light source and a tristimulus value thereof.

17. The apparatus according to claim 16, wherein the tristimulus value of the to-be-tested light source is a sum of tristimulus values of N standard light sources in the first standard light source group, wherein the tristimulus value of each standard light source is a product of RGB channel data of the each standard light source, a proportional coefficient corresponding to the each standard light source, and the conversion coefficient corresponding to the each standard light source.

18. The apparatus according to claim 12, wherein the processor is specifically configured to:
determine chromaticity coordinates of the to-be-tested light source based on the tristimulus value; and
determine the color temperature based on the chromaticity coordinates.

19. The apparatus according to claim 18, wherein the determining the color temperature based on the chromaticity coordinates comprises:
determining the color temperature based on CCT=449n³+3525n²+6823.3n+5520.33, wherein n=(x−0.3320)/(0.1858−y), CCT is a correlated color temperature of the to-be-tested light source, and x and y are the chromaticity coordinates.

20. An electronic device, comprising:
a screen; and
the apparatus for detecting a color temperature according to claim 12 arranged below the screen for detecting a color temperature of ambient light in which the electronic device is located.
